(19) United States
(12) Patent Application Publication
(10) Pub. No.: US 2012/0062709 A1
(43) Pub. Date: Mar. 15, 2012

(54) SYSTEM FOR CROSSTALK REDUCTION

(75) Inventors: Louis Joseph Kerofsky, Camas, WA (US); Sachin G. Deshpande, Camas, WA (US); Scott J. Daly, Kalama, WA (US)

(73) Assignee: SHARP LABORATORIES OF AMERICA, INC., Camas, WA (US)

(21) Appl. No.: 12/878,644

(22) Filed: Sep. 9, 2010

(51) Int. Cl. H04N 13/04; G09G 5/00

(52) U.S. Cl. 348/51; 345/581; 348/E13.075

(57) ABSTRACT

A display includes receiving a first image and a second image to be displayed on the display in order to provide a stereoscopic scene to a viewer. The first image is modified in such a manner so as to reduce the appearance of crosstalk.

### CROSS-REFERENCE TO RELATED APPLICATIONS

Not applicable.

### BACKGROUND OF THE INVENTION

The present invention relates to reducing crosstalk in a three dimensional display.

Viewing stereoscopic content on planar stereoscopic display, no matter whether LCD based or projection based, shows two images with disparity between them on the same planar surface. By temporal and/or spatial multiplexing the stereoscopic images, the display results in the left eye seeing one of the stereoscopic images and the right eye seeing the other one of the stereoscopic images. It is the disparity of the two images that results in viewers feeling that they are viewing three dimensional scenes with depth information. The display is typically used together with glasses, active or passive, so that the displayed information of the left view is provided to the left eye and the displayed information of the right view is provided to the right eye. Unfortunately, there is crosstalk between the views which results in image derogation.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates synchronized shutter glasses based display.

FIG. 2 illustrates temporal crosstalk.

FIG. 3 illustrates reduced backlight duty cycle based crosstalk.

FIG. 4 illustrates scanning backlight in synchronization with LC addressing.

FIG. 5 illustrates generation of footroom via a tonescale change.

FIG. 6 illustrates a histogram of a frame after compensation.

FIG. 7 illustrates lifting black level to reduce crosstalk.

FIG. 8 illustrates a histogram of a tone modified image after crosstalk modification.

FIG. 9 illustrates a crosstalk range of values.

FIG. 10 illustrates a crosstalk grid.

FIG. 11 illustrates a modified crosstalk grid.

FIG. 12 illustrates a resulting corrected crosstalk grid.

FIG. 13 illustrates a tone curve.

FIG. 14 illustrates a clipping range.

FIG. 15 illustrates an exemplary system including crosstalk reduction.

### DETAILED DESCRIPTION OF PREFERRED EMBODIMENT

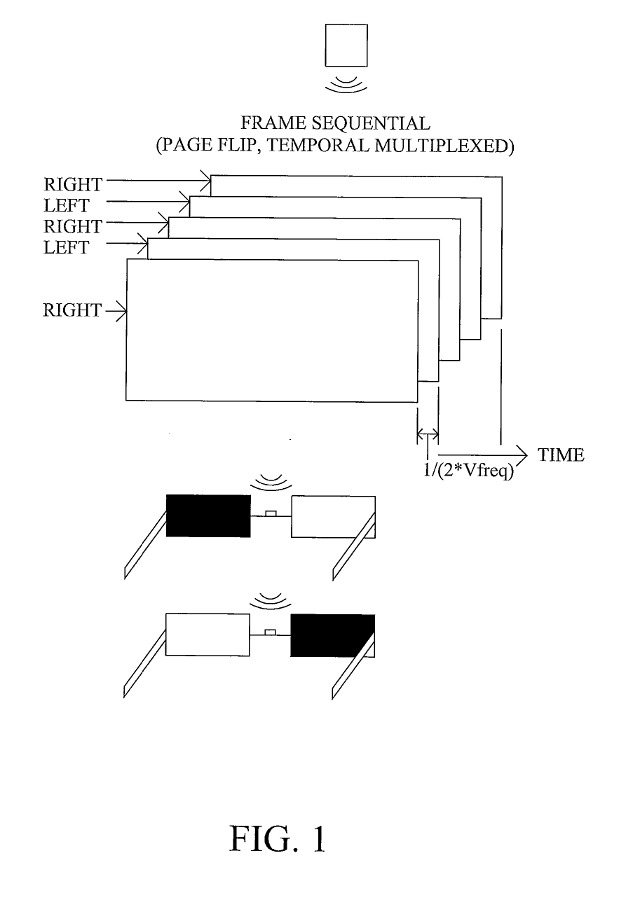

Stereoscopic display systems present three dimensional information by providing different views of a scene to each eye of a viewer. One way to classify such three dimensional systems are those that are used in conjunction with glasses and those that are used without glasses (a.k.a. auto-stereoscopic). Referring to FIG. 1, such glasses based systems are stereographic by supplying two distinct images, a right image and a left image which are synchronized with a right eye and a left eye, respectively, by the glasses. Such a system is typically referred to as a three dimensional system, such as in terms three dimensional television. In particular, the preferred glasses include active lenses which alternately, in conjunction with a left image and a right image, block (e.g., substantially inhibit the passage of light there through) and unblock (e.g., do not substantially inhibit the passage of light there through) the view to each eye.

Crosstalk in a stereographic display system generally refers to image information which passes through a lens to the unintended eye. Crosstalk is most visible proximate high contrast areas at image depths far from the screen (i.e., toward the viewer relative to the screen or away from the viewer relative to the screen) because depths further from the screen have larger disparities (horizontal displacements of image content). For example, an image edge at a large depth will occur at different horizontal positions to the left and right eye. If the signal that is intended for the left eye reaches the right eye (i.e., due to crosstalk), it will result in a perceived edge that is horizontally translated and superposed on the unintended right eye (and vice versa). The resulting perceived image includes a visible double edge. In addition, crosstalk edges usually have lower contrast than the intended edge, thus resulting in a ghost-image appearance.

A metric may be used to characterize the degree of crosstalk in a stereographic system. One technique to reduce crosstalk is based on the additive nature of the crosstalk signal. A measure of crosstalk may be based upon alpha and beta factors, which are measured or assumed. The actual output of a display when driven with data images left (L) and right (R) is given by adding alpha times R to L to form the actual left view seen. Similarly the actual right view produced by the display system is the desired image R plus alpha times the image L.

Different elements of the view may be denoted as the ‘data’ (e.g., the desired view), the ‘actual’ (e.g., the output of the display when given the ‘data’), and the ‘modified’ (e.g., the data modified to remove cross talk). When the ‘modified’ view is presented to the display, the display should produce the ‘data’ image as its ‘actual’ output.

This may be expressed as a crosstalk matrix formulation, equation 1, where beta=alpha is assumed.

$$[ \begin{matrix}{L}_{actual} \\ {R}_{actual}\end{matrix} ] = ( \begin{matrix}1 & α \\ α & 1\end{matrix} ) \cdot [ \begin{matrix}{L}_{data} \\ {R}_{data}\end{matrix} ] \qquad Equation 1$$

One technique to reduce crosstalk is to invert the crosstalk matrix of equation 1 to determine the driving data, L and R, to provide the desired actual display output. The inverse matrix may be approximated by a simpler form as shown in equation 2, because a is usually <0.1 so α² is negligible and therefore (1−α²)=1.

$$\begin{matrix}[ \begin{matrix}{L}_{mod} \\ {R}_{mod}\end{matrix} ] = {( \begin{matrix}1 & α \\ α & 1\end{matrix} )}^{- 1} \cdot [ \begin{matrix}{L}_{data} \\ {R}_{data}\end{matrix} ] \\ = \frac{1}{( 1 - {α}^{2} )} \cdot ( \begin{matrix}1 & - α \\ - α & 1\end{matrix} ) \cdot [ \begin{matrix}{L}_{data} \\ {R}_{data}\end{matrix} ]\end{matrix} \\ [ \begin{matrix}{L}_{mod} \\ {R}_{mod}\end{matrix} ] \approx \cdot ( \begin{matrix}1 & - α \\ - α & 1\end{matrix} ) \cdot [ \begin{matrix}{L}_{data} \\ {R}_{data}\end{matrix} ] \qquad Equation 2$$

It was determined that the crosstalk model described by equation 1 has limitations in the case of active shutter glasses based stereoscopic display system. In particular, it was determined that the crosstalk model of equation 1 assumes the crosstalk between the different views is constant. The crosstalk model may be modified to account for the non-instantaneous pixel addressing of a display and/or the interaction of the pixels with the backlight of a liquid crystal based display. Accordingly, both the addressing time and display brightness may influence the amount of crosstalk. The crosstalk reduction may be based on using an improved crosstalk model. Additionally, the crosstalk model should be designed in such a manner that it does not produce negative numbers for the modified images by dynamically managing a “footroom”. A negative amount of light cannot be produced so otherwise these values would be clipped to a constant, such as zero. This clipping of otherwise negative numbers reduces the crosstalk reduction effectiveness.

In a typical display, an entire frame time may be used to address all the pixels of the display. Considering a top to bottom addressing, the top row pixel is addressed and responds nearly an entire frame time before the bottom row of pixels. In conventional display applications this is not a significant issue since the bottom pixels have the value of the previous frame while the top pixels are being viewed. This slight temporal discrepancy between the top and bottom of the display is generally unnoticeable. In an active glasses stereoscopic display, a single frame time delay is significant since data will be presented to the wrong eye. The crosstalk as a result of this temporal multiplexing is a significant issue. One technique to reduce the crosstalk is to address the entire frame in less than a frame time and then flash the backlight for the remaining frame time. For example, the backlight may be off during the first half of the frame time while the display is being addressed. Once the addressing is completed, the backlight is turned on during the remaining portion of the frame time. In this manner, the pixels are not seen until they have been addressed for the appropriate view. Ignoring the pixel response time, the temporal multiplexing crosstalk is eliminated and a global crosstalk model is appropriate. Other backlight flashing and illumination techniques may likewise be used.

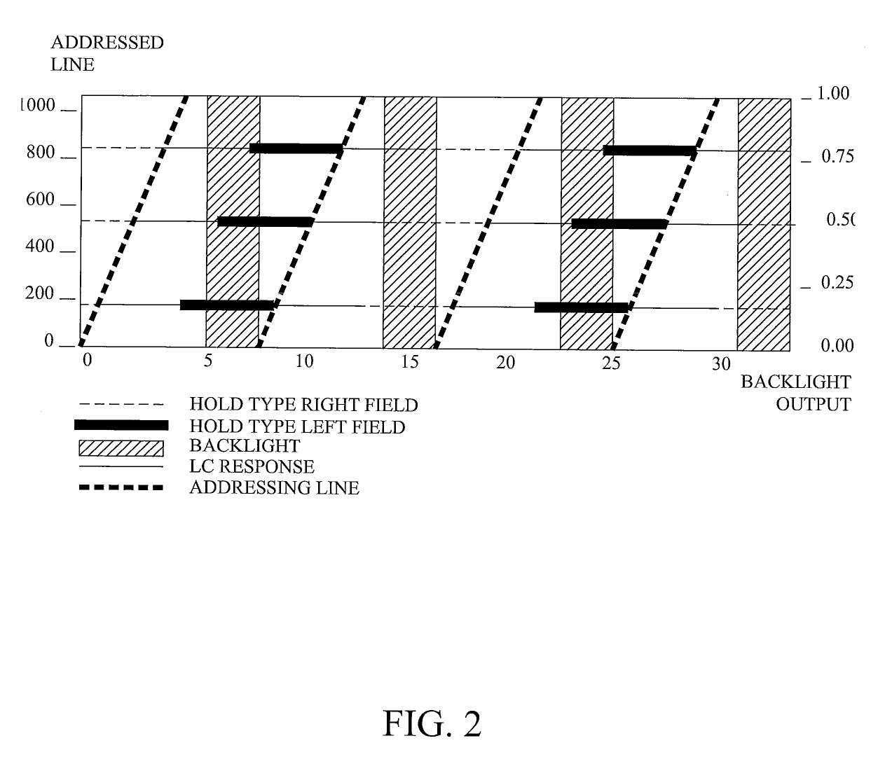

Referring to FIG. 2, when the nonzero response time of pixels is considered, data from one view influences the data in the opposite view due to the pixel response time. Accordingly, data from one view is time shifted into the opposite view. In typical addressing, top to bottom raster scan for example, the time a pixel has to respond before the backlight is active varies spatially. Thus the crosstalk factor spatially varies with displays that include row-by-row or other temporal based addressing. This spatial variation may be modeled as depending upon the vertical position of a pixel for vertical based addressed displays since the addressing time between pixels of the same row in such vertical based addressed display is generally small, as described by equation 3.

$$[ \begin{matrix}{L}_{actual} \\ {R}_{actual}\end{matrix} ] = ( \begin{matrix}1 - β ( r ) & β ( r ) \\ β ( r ) & 1 - β ( r )\end{matrix} ) \cdot [ \begin{matrix}{L}_{data} \\ {R}_{data}\end{matrix} ] \qquad Equation 3$$

As shown in FIG. 2, the pixel addressing finishes in less than half the frame time, the backlight duty cycle is 40%, and the liquid crystal response time is 50% of a frame. While the backlight is active, different pixels are in different states of response depending upon when they were addressed (and what states they are moving from and to). The first addressed lines have most likely fully responded by the time the backlight is activated. The middle lines most likely reach their final held value sometime shortly after the backlight is activated. The lines addressed toward the bottom are most likely changing their values most of the time the backlight is activated.

Even assuming a perfect extinction ratio of the active glasses so there is no crosstalk in the initial example (alpha=0), the lines addressed last are still in transition while the backlight is active and hence crosstalk is still visible. This crosstalk differs in two aspects: first a portion of data is removed from one view and replaced by data from the opposite view, second the amount of crosstalk varies with the time the LC has to respond and hence within the time it is addressed. This temporal crosstalk model including spatial variation is described in equation 4 along with the reduction computations. The temporal crosstalk may be a function of the temporal response and line position (for backlight flashing method shown in FIG. 2), and indicate as γ(r).

$$[ \begin{matrix}{L}_{actual} \\ {R}_{actual}\end{matrix} ] = ( \begin{matrix}1 - β ( r ) & β ( r ) \\ β ( r ) & 1 - β ( r )\end{matrix} ) \cdot [ \begin{matrix}{L}_{data} \\ {R}_{data}\end{matrix} ] \\ [ \begin{matrix}{L}_{mod} \\ {R}_{mod}\end{matrix} ] = \frac{1}{( {( 1 - β ( r ) )}^{2} - {β ( r )}^{2} )} \cdot ( \begin{matrix}1 - β ( r ) & - β ( r ) \\ - β ( r ) & 1 - β ( r )\end{matrix} ) \cdot [ \begin{matrix}{L}_{data} \\ {R}_{data}\end{matrix} ] \\ [ \begin{matrix}{L}_{mod} \\ {R}_{mod}\end{matrix} ] = \frac{1}{( 1 - γ ( r ) )} \cdot ( \begin{matrix}1 & - γ ( r ) \\ - γ ( r ) & 1\end{matrix} ) \cdot [ \begin{matrix}{L}_{data} \\ {R}_{data}\end{matrix} ] \\ γ = \frac{β}{1 - β} \\ [ \begin{matrix}{L}_{mod} \\ {R}_{mod}\end{matrix} ] \approx ( \begin{matrix}1 & - γ ( r ) \\ - γ ( r ) & 1\end{matrix} ) \cdot [ \begin{matrix}{L}_{data} \\ {R}_{data}\end{matrix} ] \qquad Equation 4$$

Where, the (1−γ(r)) term is approximated as 1. A joint model which includes both the extinction ratio crosstalk and the temporal multiplexing crosstalk is summarized below in equation 5. The multiple sources of crosstalk are each proportional to the opposing eye signals with various dependencies (such as position), but are additive with each other.

The two components of crosstalk may be added in the following manner,

$$[ \begin{matrix}{L}_{actual} \\ {R}_{actual}\end{matrix} ] = [ \begin{matrix}1 & 0 \\ 0 & 1\end{matrix} ] + [ \begin{matrix}0 & a \\ α & 0\end{matrix} ] + [ \begin{matrix}- β r & β r \\ β r & - β r\end{matrix} ] \qquad Equation 5$$

So the combined solution for an extinction ratio and a temporally-multiplexed crosstalk correction may be as illustrated in equation 6.

$$[ \begin{matrix}{L}_{actual} \\ {R}_{actual}\end{matrix} ] = ( \begin{matrix}1 - β ( r ) & α + β ( r ) \\ α + β ( r ) & 1 - β ( r )\end{matrix} ) \cdot [ \begin{matrix}{L}_{data} \\ {R}_{data}\end{matrix} ] \\ [ \begin{matrix}{L}_{mod} \\ {R}_{mod}\end{matrix} ] = \frac{1}{( {( 1 - β ( r ) )}^{2} - {( α + β ( r ) )}^{2} )} \cdot ( \begin{matrix}1 - β ( r ) & - ( α + β ( r ) ) \\ - ( α + β ( r ) ) & 1 - β ( r )\end{matrix} ) \cdot [ \begin{matrix}{L}_{data} \\ {R}_{data}\end{matrix} ] \\ [ \begin{matrix}{L}_{mod} \\ {R}_{mod}\end{matrix} ] = \frac{1}{( \frac{1}{1 - β ( r )} - {( \frac{α + β ( r )}{1 - β ( r )} )}^{2} )} \cdot ( \begin{matrix}1 & \frac{- α + β ( r )}{1 - β ( r )} \\ - \frac{α + β ( r )}{1 - β ( r )} & 1\end{matrix} ) \cdot [ \begin{matrix}{L}_{data} \\ {R}_{data}\end{matrix} ] \\ [ \begin{matrix}{L}_{mod} \\ {R}_{mod}\end{matrix} ] = \frac{1}{( \frac{1}{1 - β ( r )} - {λ ( r )}^{2} )} \cdot ( \begin{matrix}1 & - λ ( r ) \\ - λ ( r ) & 1\end{matrix} ) \cdot [ \begin{matrix}{L}_{data} \\ {R}_{data}\end{matrix} ] \\ λ ( r ) = \frac{α + β ( r )}{1 - β ( r )} \\ [ \begin{matrix}{L}_{mod} \\ {R}_{mod}\end{matrix} ] \approx ( \begin{matrix}1 & - λ ( r ) \\ - λ ( r ) & 1\end{matrix} ) \cdot [ \begin{matrix}{L}_{data} \\ {R}_{data}\end{matrix} ] \qquad Equation 6$$

In an LCD based system, the backlight brightness is often controlled using Pulse Width Modulation (PWM). The temporal multiplexing crosstalk caused by the pixel response time described above is dependant upon the time between when the pixel is addressed and the time when the backlight is active. With PWM brightness control, the time when the backlight is active depends upon the display brightness. Hence the crosstalk, and its reduction, further depends upon the brightness. The crosstalk factor may be modified to include variation with brightness in addition to addressed line.

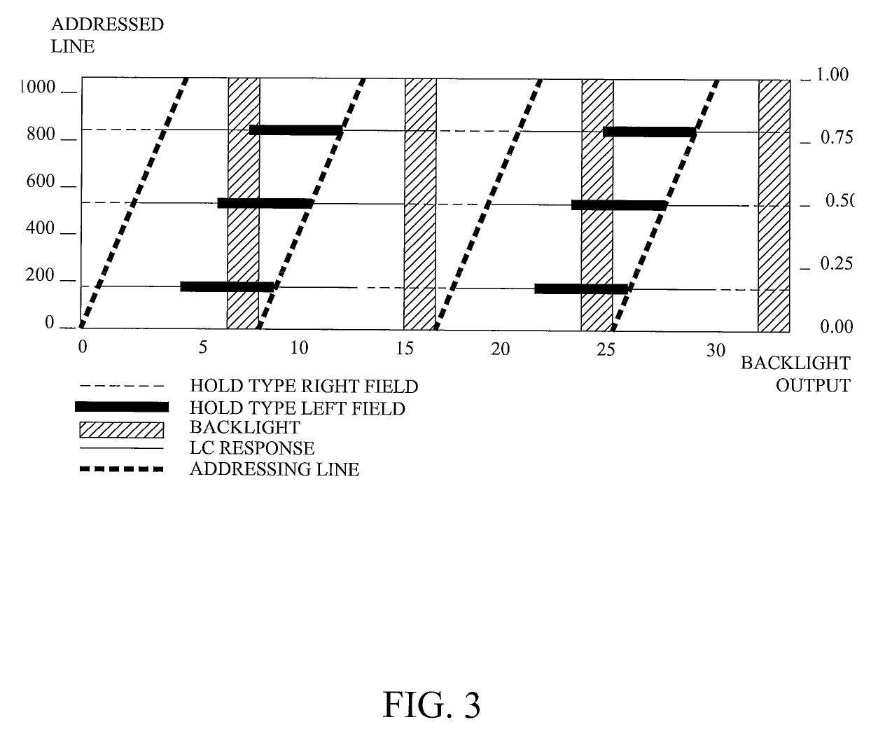

The approximation assumes the prefix scalar is 1.0 because α²(r) is approx 0. In the model above, the temporal multiplexing crosstalk depends on the time a pixel has to respond before the backlight is active. When PWM is used to control brightness, the on duty cycle of the backlight is lowered to reduce the display brightness while the backlight peak intensity is constant. In FIG. 3, the backlight is reduced to 20% duty cycle. Comparing FIG. 3 to FIG. 2, it may be observed that the backlight is off when the middle line of pixels is responding. Similarly, the fraction of the backlight on time while the last line of pixels is responding is reduced. In this example, the crosstalk is spatially reduced compared to FIG. 3 (in particular, lines 0-600).

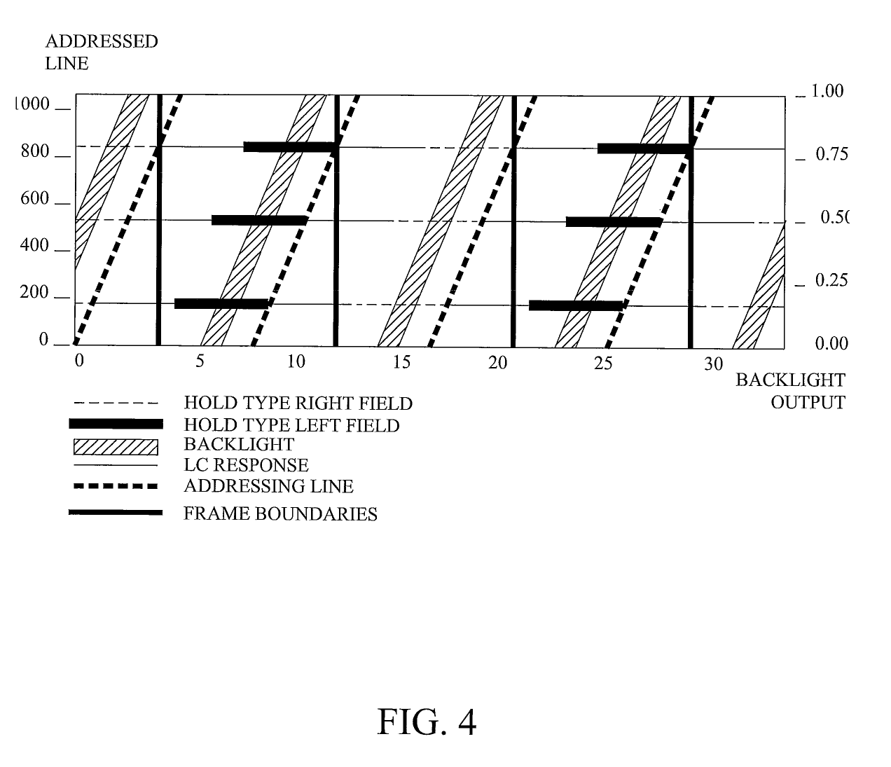

This PWM dependence of the crosstalk correction may be reduced by making the term beta depend on both the row (r) and the backlight level, as illustrated in FIG. 4 and equation 7.

$$Crosstalk correction with spatial and brightness dependence \\ [ \begin{matrix}{L}_{actual} \\ {R}_{actual}\end{matrix} ] = ( \begin{matrix}1 - β ( r , b ) & α + β ( r , b ) \\ α + β ( r , b ) & 1 - β ( r , b )\end{matrix} ) \cdot [ \begin{matrix}{L}_{data} \\ {R}_{data}\end{matrix} ] \\ [ \begin{matrix}{L}_{mod} \\ {R}_{mod}\end{matrix} ] = \frac{1}{( {( 1 - β ( r , b ) )}^{2} - {( α + β ( r , b ) )}^{2} )} \cdot ( \begin{matrix}1 - β ( r , b ) & - ( α + β ( r , b ) ) \\ - ( α + β ( r , b ) ) & 1 - β ( r , b )\end{matrix} ) \cdot [ \begin{matrix}{L}_{data} \\ {R}_{data}\end{matrix} ] \\ [ \begin{matrix}{L}_{mod} \\ {R}_{mod}\end{matrix} ] = \frac{1}{( \frac{1}{1 - β ( r , b )} - {( \frac{α + β ( r , b )}{1 - β ( r , b )} )}^{2} )} \cdot ( \begin{matrix}1 & - \frac{α + β ( r , b )}{1 - β ( r , b )} \\ - \frac{α + β ( r , b )}{1 - β ( r , b )} & 1\end{matrix} ) \cdot [ \begin{matrix}{L}_{data} \\ {R}_{data}\end{matrix} ] \\ [ \begin{matrix}{L}_{mod} \\ {R}_{mod}\end{matrix} ] = \frac{1}{( \frac{1}{1 - β ( r , b )} - {λ ( r , b )}^{2} )} \cdot ( \begin{matrix}1 & - λ ( r , b ) \\ - λ ( r , b ) & 1\end{matrix} ) \cdot [ \begin{matrix}{L}_{data} \\ {R}_{data}\end{matrix} ] \\ λ ( r , b ) = \frac{α + β ( r , b )}{1 - β ( r , b )} \\ [ \begin{matrix}{L}_{mod} \\ {R}_{mod}\end{matrix} ] \approx ( \begin{matrix}1 & - λ ( r , b ) \\ - λ ( r , b ) & 1\end{matrix} ) \cdot [ \begin{matrix}{L}_{data} \\ {R}_{data}\end{matrix} ] \qquad Equation 7$$

Clipping may be reduced, or otherwise avoided, by modifying the images so that the crosstalk reduction does not produce negative results. For purposes of illustration, the reduction of negative results may be referred to as “footroom”. Normally, a minimum code value of 0 corresponds to the minimum light level the display can produce. So code values less than zero cannot be displayed, therefore they are normally set to zero. The footroom modification raises the image's minimum value to allow room for code value modulations below the minimum, virtually permitting modulations below “zero” (e.g., the minimum), thus avoiding the clipping restriction. A negative side-effect of providing the footroom for crosstalk compensation is that the black level is elevated thus reducing the contrast of the display. Preferably, the footroom technique selectively provides footroom, as needed, since crosstalk visibility is image-dependent. This reduces the negative impact of providing footroom. In addition, the footroom (and/or headroom) technique may be spatially adaptive and/or temporally adaptive.

One characterization of crosstalk between images may be as follows.

$$Ldisplay = Lsource + α Rsource$$

$$Lcompensated = Lsource - α Rsource$$

$$Ldisplayed \& compensated = {Lsource}_{\{ Digital operation \}} - α Rsource + {α Rsource}_{\{ Physical operation \}}$$

One distinction between the physical operation occurs in the luminance domain, with analog “bit precision”, and the α Rsource term is not negative. The digital operation can be negative, is usually limited in bit-depth, and is preferred to occur on the gamma corrected domain. A more accurate version of the equation talking into account the physics limitations is:

Ldisplayed&compensated=max[0,Lsource−αRsource]+max[0,αRsource]

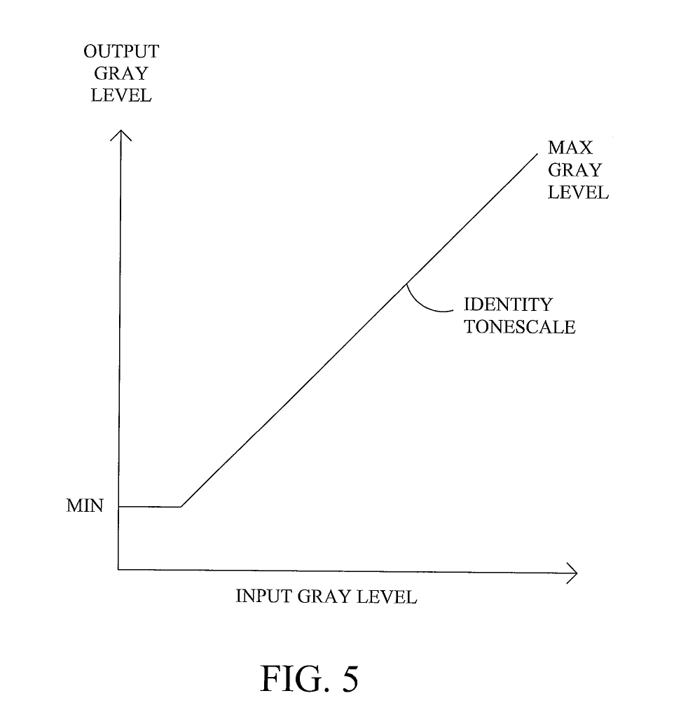

Since in most digital imaging systems the code value 0 is assumed mapped to luminance zero, then the compensated signal, Lcompensated, cannot have negative values. This means that crosstalk occurring in the black (i.e., 0) regions of an image cannot be compensated. However, if the black level of the input image is lifted (such as via a tonescale modification, as shown in the FIG. 5), then a “Footroom” may be provided, allowing for values below black (i.e below 0 of the input image). These are still above zero in the compensated image, and thus can be displayed, and thus allowing the compensation to take effect. A similar technique may be applied to achieve headroom at the upper end of the tone scale. While this is described in terms of modification of the tone scale, it is to be understood that the modification may be done in any suitable domain, including the luminance domain.

One limitation of including “footroom” is that the black level of the image is elevated. In many cases this level shift may not be noticeable, such as high ambient viewing, very large contrast ranges, and image content (example, the black regions of input value 0 are very small). Thus crosstalk compensation may be applied without significant contrast loss, due to lifting the black levels by using adaptive footroom. In addition, the adaptive footroom may likewise be included on the bright end of the display range as adaptive headroom.

To facilitate explanation of some embodiments a few terms may be generally defined. It is to be understood that these definitions are merely for purposes of illustration.

Extinction Ratio may be used to describe the (max transmittance/min transmittance) and traditionally is due to the combination of the polarized filter on the emissive or projective side, and the polarized filter in the glasses.

Crosstalk ratio may be defined as 1/extinction ratio. Typical ranges of the crosstalk ratio are: 10%—shuttered glasses approaches (temporal multiplexing).

Cross image may be defined as the image from one of the stereo pair views that leaks into the other view.

Source image may be defined as the intended image for the specific eye (view). That is, the final viewed image with crosstalk problem is the Viewed Image=Source Image+crosstalk_factor×Crosslmage.

The crosstalk image is the viewed image with the source image removed, that is, isolating the crosstalk. The Crosstalk image may be defined as the Viewed Image−Source Image=Source Image+crosstalkfactor×CrossImage−Source image=crosstalk factor×Cross image.

The compensation image may be defined as the negation of the crosstalk image. The Compensation image−crosstalk image=−crosstalk factor×Cross image.

The compensated viewed image may be defined as the crosstalk contaminated image with the crosstalk compensation, and is intended to match the source image. The Compensated Viewed image=Viewed image+compensation image=source image+crosstalk_factor×cross image+−crosstalk image=source image.

Crosstalk behavior summary (including both physical and visual effects) may include the following characteristics.

(1) The crosstalk amplitude depends on luminance of ‘crossed’ signal (i.e, the other eye).

(2) The contrast of crosstalk is higher in the dark regions, hence visibility is higher
(i) ΔUL argument, where L is the local surround of source image, being low.
(ii) ΔL depends on the crosstalk factor, and the luminance of the crosstalk image at that position—neither terms depend on content of source image.
(iii) A constant amplitude in the cross image spanning across different gray levels of the Source image, will have a higher crosstalk contrast in the dark regions.

(3) Can not correct crosstalk in dark regions due to clipping (either code values or light).
(i) Normally cv=0 is mapped to L=0, or close.
(ii) Exceptions include BL-modulation.
(iii) Usually the code value mapped to darkest possible light lelvle (for given backlight level).

(4) Crosstalk in low disparity regions (i.e near the display screen depth) is not visible as ghosting (double edges) but may still cause blurring or edge distortions)).
(i) For example, at 0 depth, the cross image and source images are locally identical. The crosstalk simply adds brightness.
(ii) As the depth of the local feature increases, the x-positional difference (disparity) increases. For small distances, this will cause edge blur. For larger distances, this will cause double edges (a.k.a ghosting, diplopia).

(5) Amplitude of cross signal can be reduced if it is in the high brightness end of tonescale—(headroom reduction concept).
(i) Harder to notice changes in the bright-end are more than in the dark-end, even in the traditional gamma corrected cod value domain, because that domain still has higher ΔCV visibility in the dark end of the tone scale (that domain does not properly match the HVS tonescale).
(ii) This allows crosstalk reduction not by compensation, but by prevention (by reducing the amplitude of the crosstalk image).

(6) As display contrast range increases, the crosstalk is easier to see.

(7) As the display gets brighter, the crosstalk is easier to see.

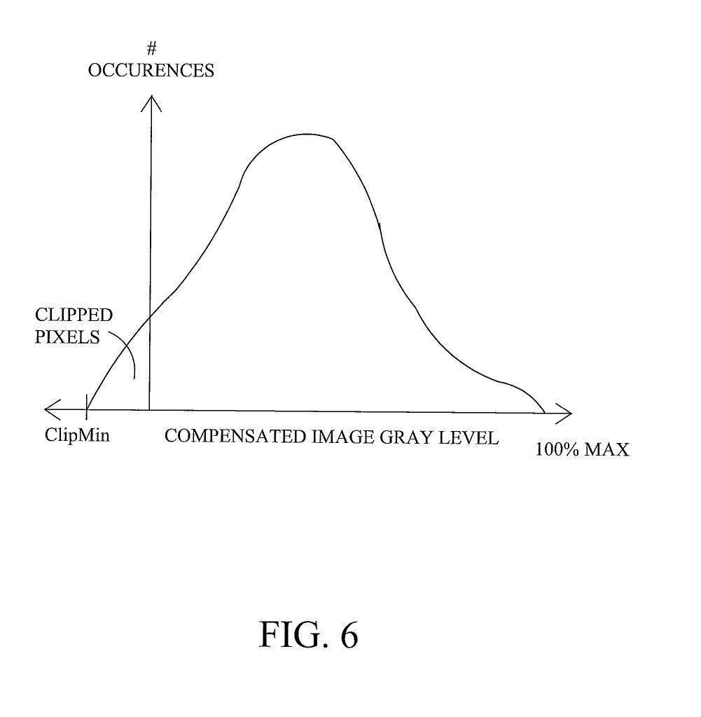

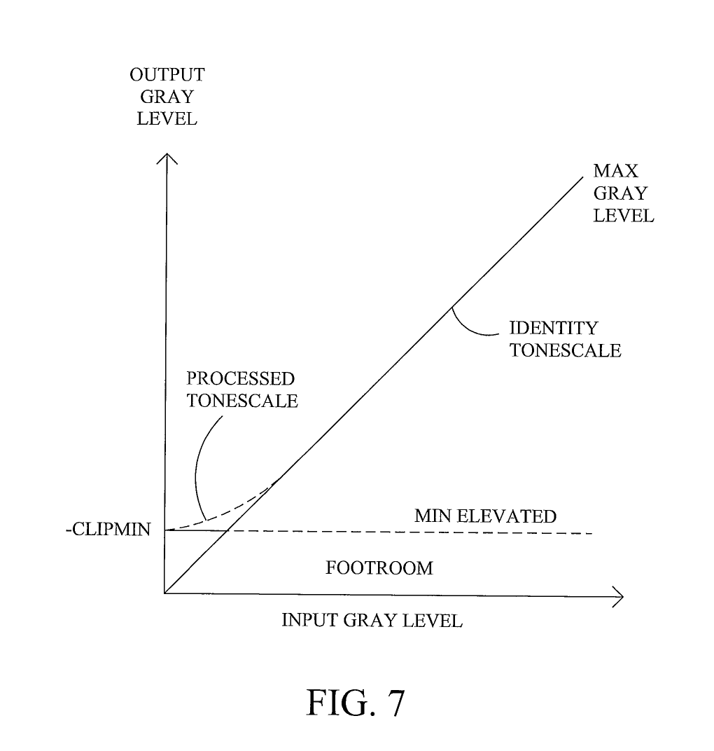

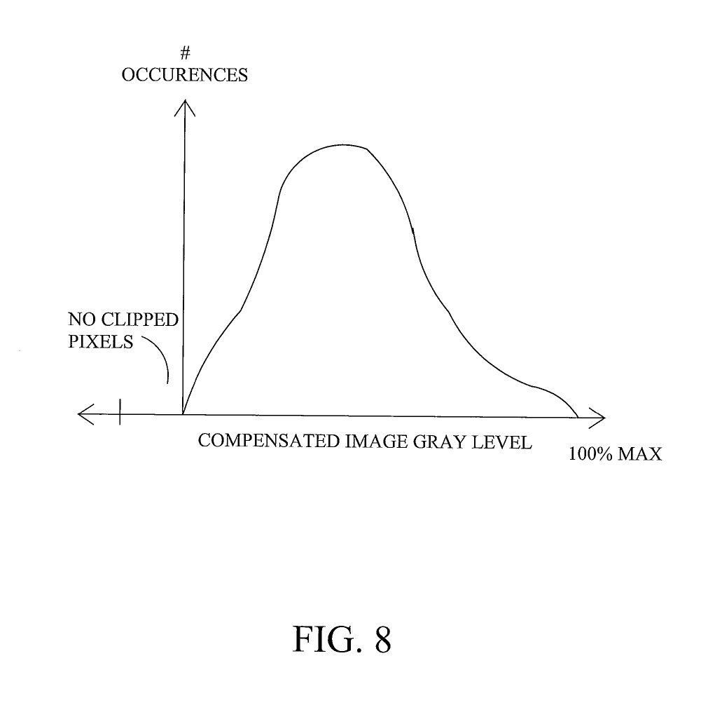

One or more of these factors may be considered when implementing an adaptive footroom and/or headroom technique. Equation 7 may be used to generate the compensated image. Then the minimum value may be determined, such as the minimum of the compensated image or determined based upon a statistical measure such as a histogram. Referring to FIG. 6, the clipped value may be used as a basis upon which to shape the tonescale (see FIG. 7) so that the zero input maps to—Clipmin (which is a positive value). Referring to FIG. 8, the input image may be processed using the modifying tonescale and then compensated via the matrix in equation 7. The compensated image may likewise be directly modified. The resulting image may be compensated without values <0, as illustrated by the histograph.

In some cases, the footroom may be adjusted as needed based on the histogram of the crosstalk compensation image, which incorporates the location of the source and crosstalk signals in the histogram. One way to achieve this is to first generate the Lcompensated image, allowing for out of range values, then use the histogram of compensated image. Then shift the tonescale (or image on the tonescale) so that the negative regions are brought into positive values. Some reduction of clipping at the bright end (and/or dark end), contrast change (reduction), and crosstalk are achieved.

In some cases the compensated image may be analyzed as an image map, and locally modified to allow for the negative value to be elevated to be above zero (as needed for compensation). The modification may be an offset in the code value domain or a tonescale change to locally vary the tonescale. Preferably to reduce distortions, the result is spatially low pass filtered.

The spatial low pass filtering may be based upon the flare OTF of the visual system. Also, the spatial low pass filtering may be based upon blending the compensated image with an identity tonescale (thus maintaining full black) with the tonescale modified compensated image (where tonescale selected by elevating black to allow footroom). The blending factor may be pixel-dependent and based on the compensated image after being negatively rectified (keeping all values <0 unchanged, setting all others to 0) and the low-pass filtered. Since the blending function is pixel-dependent, and controlled by the low pass filter of the negatively rectified, the high values mix in more of the compensated with modified tonescale.

The tonescale changes from frame to frame are preferably low-pass filtered, with the exception of scene cuts using a scene cut detector, in which they are allowed to change rapidly. This may be applied to the crosstalk correction for extinction ratio cases, as well as temporal multiplexed cases. For such temporal multiplexed systems, the crosstalk is not simply the L onto the R and vice versa within a single frame. The crosstalk is from frame t to frame t+1. The typical sequence would be: 1L 1R 2L 2R 3L 3R etc., so that the crosstalk on frame 1R comes from 1L, the crosstalk on frame 2L also comes from 1R at least in part.

While the equations and descriptions have been illustrated in terms of L and R pairs, they can be generalized to t and t+1 pairs, where the specific stereo sequence determines which L and R frames are used.

The crosstalk also occurs multiplicatively in the luminance domain, and may be modified in the luminance domain. This may involve converting from the gamma corrected domain to the luminance domain. Another technique is to map the correction from the luminance domain to the gamma corrected domain as illustrated in equation 8.

$$\begin{matrix}{L}_{mod} = {L}_{data} - α \cdot {R}_{data} & {R}_{mod} = {R}_{data} - α \cdot {L}_{data} \\ {l}_{mod} = {( {l}_{data}^{γ} - α \cdot {r}_{data}^{γ} )}^{\frac{1}{γ}} & {r}_{mod} = {( {r}_{data}^{γ} - α \cdot {l}_{data}^{γ} )}^{\frac{1}{γ}} \\ {l}_{mod} = {l}_{data} \cdot {( 1 - α \cdot \frac{{r}_{data}^{γ}}{{l}_{data}} )}^{\frac{1}{γ}} & {r}_{mod} = {r}_{data} \cdot {( 1 - α \cdot \frac{{l}_{data}^{γ}}{{r}_{data}} )}^{\frac{1}{γ}} \\ {l}_{mod} = {l}_{data} \cdot Gain ( β \cdot \frac{{r}_{data}}{{l}_{data}} ) & {r}_{mod} = {r}_{data} \cdot Gain ( β \cdot \frac{{l}_{data}}{{r}_{data}} )\end{matrix} \qquad Equation 8$$

This is particularly useful when the displayed tonescale is close to a strict gamma relationship. It is also applicable to both the temporal multiplexed shutter glasses or the solely extinction ratio-based passive glasses.

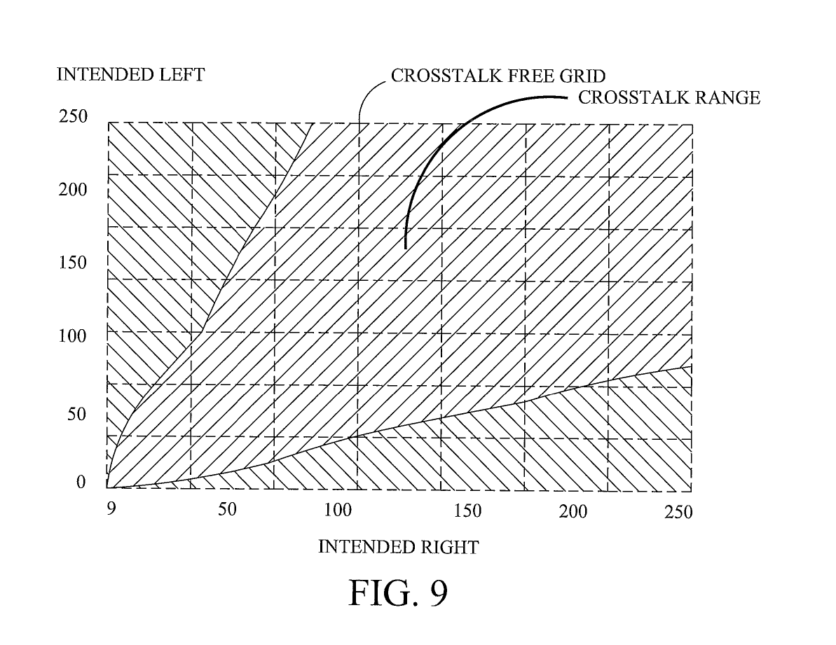

Referring to FIG. 9 a modified technique to select an appropriate tone-scale for an image is illustrated. Since the same pixels are used to display the left image and the right image, albeit at different times, there are transitions that are not suitable for being displayed since the transition will not sufficiently complete in the time available. The upper left region and the low right regions of the values are the transitions between the intended left and intended right (and the intended right and the intended left) that are not suitable for being properly displayed. As expected, the central region where the left image value and the right image value are generally the same are suitable for being properly displayed. In this manner, the transition value pairs that are suitable for being displayed in a stereoscopic manner may be selected.

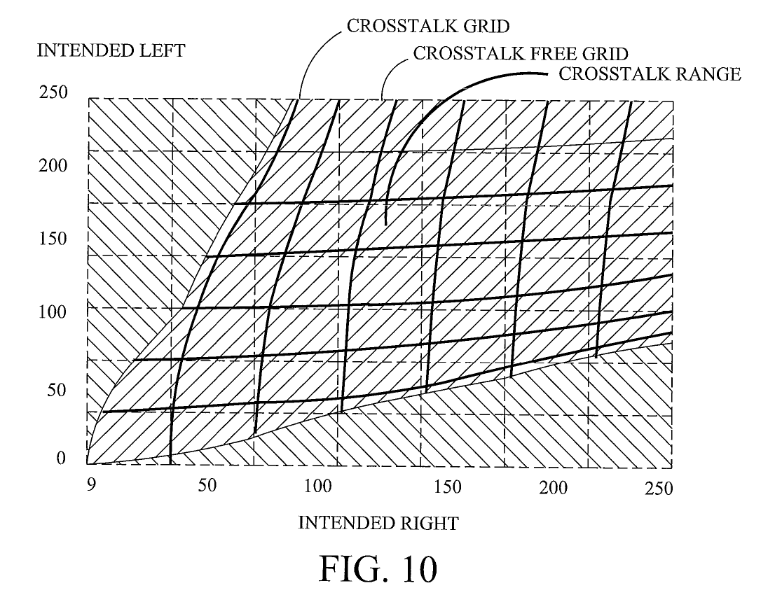

Referring to FIG. 10, with the introduction of crosstalk between the two images, the values provided to the display are modified in their effective appearance to the viewer. The characterization may be illustrated by plotting for each view pair sent to the display, the corresponding view pair which a crosstalk free display would require to provide the same experience to each view. This set of values is shown in FIG. 10 by superimposing a crosstalk input grid on FIG. 9. Accordingly, it may be observed that the crosstalk input grid is generally shifted to the right and generally shifted up, relative to the orthogonal crosstalk free grid. It may be observed that the range of crosstalk output is smaller than the input. For example, the crosstalk display can not display a maximum white/minimum black pair. Also, the warping of the grid lines within the crosstalk range cause visible crosstalk. However, the modifications suitable to reduce these different sources of crosstalk are different.

Within the range of the crosstalk transform, techniques can be applied to reduce or otherwise eliminate the warping and hence cancel this source of crosstalk. One such technique for a LCD display is the reduction of response time for intermediate gray level transitions to reduce the warping of the gridlines within the crosstalk range. Another such technique is to modify the data sent to the display using a pre-warping which will cancel or otherwise reduce the warping as a result of the display's crosstalk. These techniques are preferably applied to the pixel pairs within the crosstalk range and not applied (at least to the same extent) to the pixel pairs outside the crosstalk range.

The pre-warping technique may be based upon a given pixel pair in the crosstalk range, where the crosstalk reduction includes selecting a modified pixel pair that maps to the desired pair under the crosstalk transformation. More generally, given a desired pair, the system determines a modified pixel pair which maps closest to the desired pair under the crosstalk mapping. For out of range pixel pairs, this locates the pixel pair on the boundary of the crosstalk range which is nearest to the desire pixel pair. For purposes of identification, this technique may be referred to as the projection onto range. Once a point within the crosstalk range is identified, a pair of pixel values which map under the crosstalk transformation to this value is selected. This defines the modified pixel pair, as illustrated in equation 9.

(\hat{r},\hat{l})=arg min∥CT(r,l)−CT(x,y)∥² Equation 9

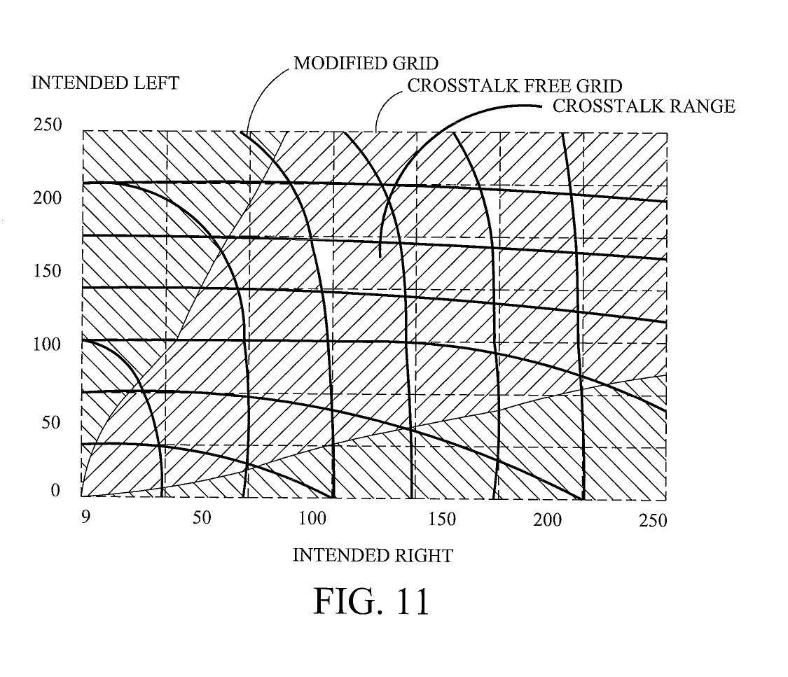

The pre-warping transformation can be visualized similarly to the crosstalk transformation, as illustrated in FIG. 11.

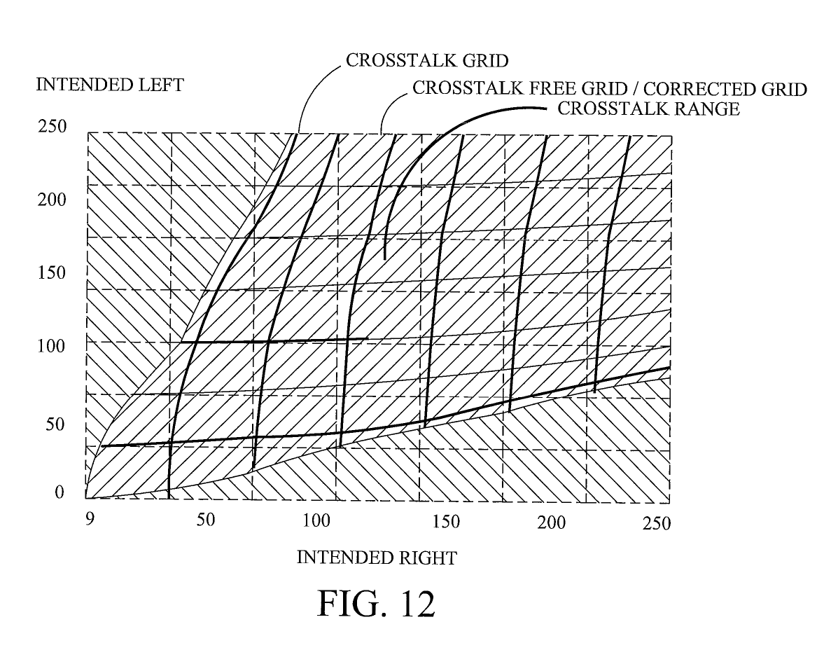

To evaluate the crosstalk cancellation (e.g., reduction) of the range projection technique, the system may characterize the pre-warping followed by display on the crosstalk display. The result is that for pixel pairs within the crosstalk range, the correction is substantially the same as the crosstalk free grid, as illustrated in FIG. 12.

For pixels outside of the range of the crosstalk transform a separate or additional technique should be applied. The technique should be applied in such a manner that in image areas of low or insignificant crosstalk, which is typically the majority of the image, is not modified or otherwise the modification is minimal. Otherwise significant image distortion may result.

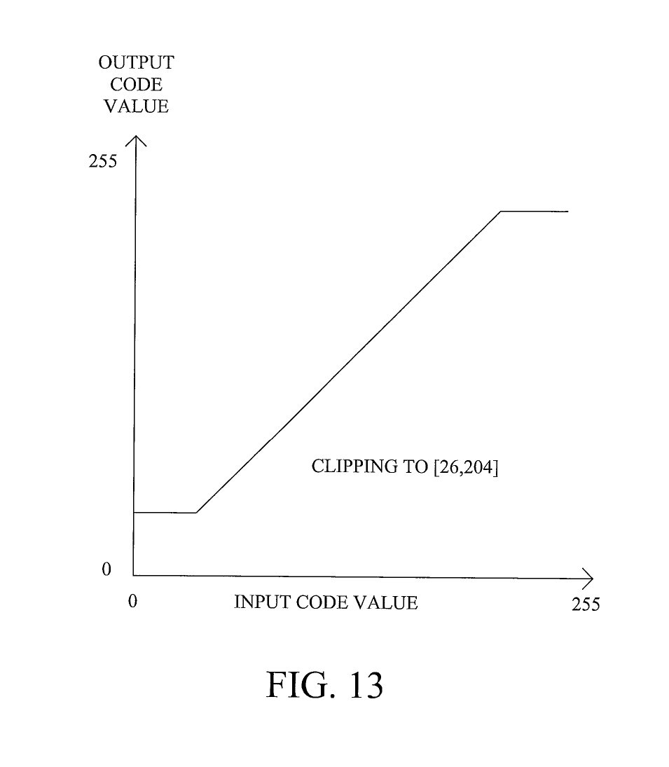

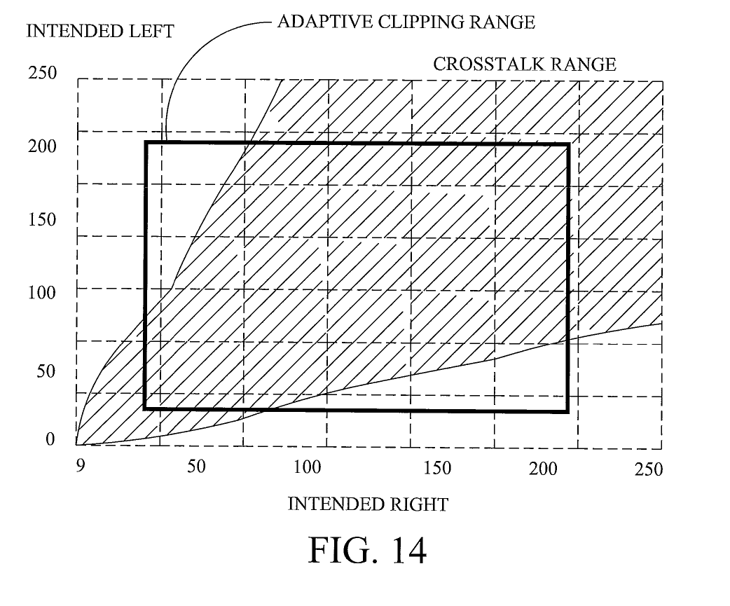

One suitable technique includes using an adaptive two parameter preprocessing model. The preprocessing model is determined by a tonescale which is applied independently to the two views, such as illustrated by FIG. 13. The tonescale is defined by two parameters the lower clipping limits L and the upper clipping limit H. The lower clipping limit L or the upper clipping limit H may be omitted, if desired. The input and output code values in the middle of the range may likewise be modified, as desired. The parameters L and H are preferably selected adaptively based on the image content. The range of each tonescale operator defines a rectangle in the view pair range, such as illustrated in FIG. 14.

In addition, the tonescale selection may use a soft rounded curve based clipping rather than a hard abrupt transition based clipping to preserve color tonescale when mapping into the tonescale range.

The selection of the tonescale parameters may be done in any suitable manner. One such technique includes given an image pair and a tonescale operator T, an error function may be defined. The adaptive technique selects the operator T from the two parameter family which minimizes the error function. Given a tonescale there is distortion both in the tonescale applied to an individual image, E_{TS}, and in crosstalk which arises when the range of the preprocessing operation lies outside of the crosstalk range, E_{CT}. The system weights these components by 1-D and 2-D image histograms respectively and form a weighted sum of these terms to define a cost function. The tonescale parameters which minimize this error are selected. The image content determines the histograms which in turn determine the error function equation 10.

$${E}_{TS} ( p , T ) = {‖ p - T ( p ) ‖}^{2} \\ {E}_{CT} ( p , q , T ) = {‖ 〈 T ( p ) , T ( q 〉 ) , Range ( CT ) ‖}^{2} \\ {E}_{img} ( {H}_{1} , {H}_{2} , T , W ) = {\sum }_{p} {H}_{1} ( p ) \cdot {E}_{TS} ( p , T ) + W \cdot {\sum }_{r , l} {H}_{2} ( r , l ) \cdot {E}_{CT} ( l , r , T ) \\ \hat{T} ( {H}_{1} , {H}_{2} ) = argmin \{ {E}_{img} ( {H}_{1} , {H}_{2} , T , W ) \} \qquad Equation 10$$

The system may approximate the boundary of the crosstalk range by two straight lines between the (0,0) and white to black and black to white crosstalk points respectively, as illustrated in FIG. 14.

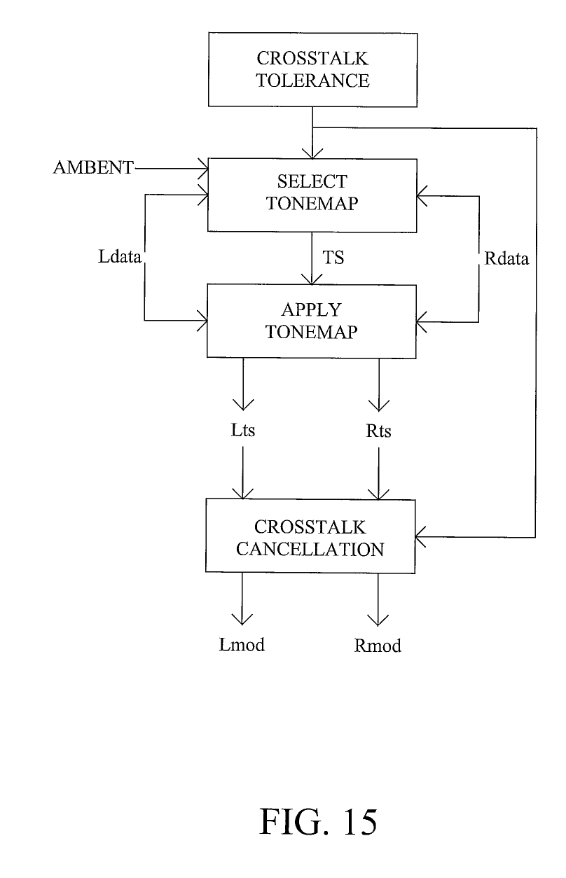

Referring to FIG. 15, an exemplary system may include the α as an input crosstalk tolerance. The system initially selects an appropriate tonemap based upon the crosstalk factor and the image pairs. This may further be based upon the ambient lighting conditions. The selection of the tone map may be based upon the Ldata and the Rdata. The Ldata and/or the Rdata is then modified based upon the applied tonemap selected. A modified set of Ldata (Lts) and/or Rdata (Rts) is then processed using the crosstalk cancellation (e.g., reduction) technique. The output of the crosstalk cancellation is a Lmod and/or Rmod images suitable for being displayed on the display.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A display comprising:
(a) receiving a first image and a second image to be displayed on said display in order to provide a stereoscopic scene to a viewer;
(b) modification of said first image in such a manner so as to reduce the crosstalk between said first image and said second image being displayed on said display by accounting for non-instantaneous pixel addressing of the pixels of said display based upon a scan order of said display.

2. The display of claim 1 further comprising glasses associated with said display, wherein said glasses selective inhibit the passage of light there through each of a right lens and a left lens.

3. The display of claim 1 wherein said left lens is synchronized with displaying said first image and said right lens is synchronized with displaying said second image.

4. The display of claim 1 wherein said non-instantaneous pixel addressing is based upon a vertical position of respective pixels.

5. The display of claim 1 wherein said non-instantaneous pixel addressing is based upon a scan order of respective pixels of said display.

6. The display of claim 1 wherein said accounting for non-instantaneous pixel address is a function of a temporal response of pixels of said display and an addressing order of pixels of said display.

7. A display comprising:
(a) receiving a first image and a second image to be displayed on said display in order to provide a stereoscopic scene to a viewer;
(b) modification of said first image in such a manner so as to reduce the crosstalk between said first image and said second image being displayed on said display by accounting for differences in the illumination duration of a backlight of said display resulting from a time varying illumination technique.

8. The display of claim 7 wherein said illumination technique includes pulse width modulation.

9. The display of claim 7 wherein said time varying illumination technique is based upon the brightness level of a backlight for said display.

10. The display of claim 7 modification of said first image is further based upon the addressing of said display.

11. A display comprising:
(a) receiving a first image and a second image to be displayed on said display in order to provide a stereoscopic scene to a viewer;
(b) modification of said first image in such a manner so as to reduce the crosstalk between said first image and said second image being displayed on said display by dynamically adjusting a tone scale applied to said first image to at least one of increase the black level of at least a portion of said display or decrease the luminance level of at least a portion of said display.

12. The display of claim 11 wherein said increased black level results in reducing the clipping of lower pixel values of said first image.

13. The display of claim 12 wherein said reducing eliminates said clipping.

14. The display of claim 11 wherein said adjusted tone scale includes increasing the lower tone scale values.

15. The display of claim 11 wherein said modification is based upon a histogram of said first image.

16. The display of claim 11 wherein said modification is applied differently to different regions of said first image.

17. A display comprising:
(a) receiving a first image and a second image to be displayed on said display in order to provide a stereoscopic scene to a viewer;
(b) modification of said first image in such a manner so as to reduce the crosstalk between said first image and said second image being displayed on said display based upon corresponding pixels in said second image to a value such that when crosstalk occurs as a result of displaying said first image and said second at least a portion of the displayed images are substantially crosstalk free in appearance.

18. The display of claim 17 wherein said modification is generally a decrease in code values of said first image.

19. A display comprising:
(a) receiving a first image and a second image to be displayed on said display in order to provide a stereoscopic scene to a viewer;
(b) modification of said first image in such a manner so as to reduce the crosstalk between said first image and said second image being displayed on said display based upon crosstalk measurements of a sample display representative of said display.

20. The display of claim 19 wherein said crosstalk model is based upon crosstalk measurements of a sample display representative of said display.

21. The display of claim 20 wherein said crosstalk measurements for said sample display consists of crosstalk values in a first image that are a function of pixel value in said first image and a second image.
